(19) United States
(12) Patent Application Publication
(10) Pub. No.: US 2025/0196921 A1
(43) Pub. Date: Jun. 19, 2025

(54) STEERING WHEEL ARRANGEMENT FOR A MOTOR VEHICLE

(71) Applicant: KOSTAL Automobil Elektrik GmbH & Co. KG, Luedenscheid (DE)

(72) Inventors: Martin DEITMERG, Lüdenscheid (DE); Knut MOLDENHAUER, Hagen (DE)

(73) Assignee: KOSTAL Automobil Elektrik GmbH & Co. KG, Luedenscheid (DE)

(21) Appl. No.: 19/071,151

(22) Filed: Mar. 5, 2025

Related U.S. Application Data
(63) Continuation of application No. PCT/EP2023/077472, filed on Oct. 4, 2023.

(30) Foreign Application Priority Data
Oct. 6, 2022 (DE) 102022003710.6

(51) Int. Cl. B62D 15/02; B62D 1/06

(52) U.S. Cl. CPC B62D 15/0215; B62D 1/06

(57) ABSTRACT

A steering wheel arrangement for a motor vehicle is provided. The steering wheel arrangement includes a steering wheel, a steering angle measuring arrangement for detecting the position of the steering wheel at a given moment, an electrical steering wheel heater, and a coil spring cassette that contains a ribbon cable through which flows an operating current of the steering wheel heater. The steering wheel arrangement further includes a current control device for the steering wheel heater. The current control device limits the operating current of the steering wheel heater depending on the detected position of the steering wheel.

### CROSS-REFERENCE TO RELATED APPLICATIONS

This application is a continuation of International Application No. PCT/EP2023/077472, published in German, with an international filing date of Oct. 4, 2023, which claims priority to DE 10 2022 003 710.6, filed Oct. 6, 2022, the disclosures of which are hereby incorporated in their entirety by reference herein.

### TECHNICAL FIELD

The present invention relates to a steering wheel arrangement for a motor vehicle, the steering wheel arrangement including a steering wheel, a steering angle measuring system for detecting the present steering wheel position, an electric steering wheel heater, and a coil spring cartridge (or clock spring cassette) that contains at least one ribbon cable through which the operating current of the electric steering wheel heater flows.

### BACKGROUND

Modern motor vehicles, practically without exception, have a steering angle measuring system that electronically detects the present (or current) steering wheel position. The detected steering angle is necessary, for example, for controlling electric power steering. The steering angle measuring system includes analog or digital steering angle sensors that are arranged on the steering wheel and/or on the steering column.

Relaying of the signals of these steering angle sensors usually takes place via ribbon cables that are situated inside a cable chamber of a so-called coil spring cartridge. The ribbon cables can be rolled up and unrolled such as when the steering wheel rotates. A coil spring cartridge is generally used to electrically couple components of a steering wheel arrangement that are rotatable with respect to one another. To electrically couple the rotatable components of the steering wheel arrangement, the coil spring cartridge has at least one stationary (or fixed) housing part (stator) that is connected to the steering column, and a rotatable housing part (rotor) that is rotatable with respect to the stator and is connected or coupled to the steering wheel.

An increasingly popular feature of motor vehicles is a device for electrically heating the steering wheel rim, referred to here as an electric steering wheel heater. The operating current for the electric steering wheel heater is generally also routed inside via at least one ribbon cable contained within the coil spring cartridge. Relatively high current intensities must be transferred to achieve a comfortable, rapid heating of the steering wheel rim.

The electrical power that is transferable by via a ribbon cable of a coil spring cartridge depends on the position of the ribbon cable in the cable chamber of the coil spring cartridge. In this regard, the most unfavorable cases occur in steering wheel positions in which the ribbon cable is completely wound onto either the rotor or the stator of the coil spring cartridge, since this results in the highest electrical power density in the ribbon cable. The unavoidable ohmic heat generation in the ribbon cable is thus concentrated in a small space. Due to the compact arrangement of the ribbon cable, the generated heat may be dissipated poorly.

The situation is much better in steering wheel positions in which the ribbon cable is evenly distributed over the rotor and the stator as well as in the intermediate space between them inside the coil spring cartridge. In this situation, the heat generated by the operating current is distributed over a relatively large area. In addition, with a larger portion of the surface of the ribbon cable being surrounded by air, the generated heat can be dissipated.

The exact steering wheel positions in which the ribbon cable conducting the operating current to the electric steering wheel heater is wound most tightly inside the coil spring cartridge depend on the precise arrangement of the ribbon cable within the coil spring cartridge. In the following discussion, without limitation of universality or generality, it is assumed that these most unfavorable cases occur in the two steering wheel positions in which the steering wheel is deflected as far as possible to the right or to the left.

The middle steering wheel positions in the vicinity of the straight-ahead travel of the motor vehicle are then least critical, since here the ribbon cable is loosely positioned in the coil spring cartridge.

To avoid overheating of the ribbon cable, in the past the maximum transferable operating current intensity has been limited by the most critical state, “ribbon cable completely wound.” Due to this limitation, assuming the most unfavorable state, the heating up of the steering wheel rim takes a relatively long time.

### SUMMARY

An object is to provide a steering wheel arrangement that allows rapid and reliable heating of the steering wheel by means of an electric steering wheel heater.

This object is achieved according to the present invention by providing a current control device for the electric steering wheel heater, which limits the operating current of the electric steering wheel heater as a function of the detected steering wheel position.

In carrying out the above and/or other objects, a steering wheel arrangement for a motor vehicle is provided. The steering wheel arrangement includes a steering wheel, a steering angle measuring system for detecting a position of the steering wheel, an electric steering wheel heater, a coil spring cartridge containing a ribbon cable through which an operating current of the electric steering wheel heater flows, and a current controller. The current controller limits the operating current of the electric steering wheel heater as a function of the position of the steering wheel.

The ribbon cable in a straight-ahead position of the steering wheel is wound least tightly inside the coil spring cartridge and in maximum deflected positions of the steering wheel is wound most tightly inside the coil spring cartridge. The current controller minimally limits the operating current of the electric steering wheel heater in the straight-ahead position of the steering wheel (minimally limits means the operating current can be relatively large). The current controller maximally limits the operating current of the electric steering wheel heater in the maximum deflected positions of the steering wheel (maximally limits means the operating current can only be relatively small).

The current controller may limit the operating current of the electric steering wheel heater to a greater extent as the position of the steering wheel approaches one of the maximum deflected positions of the steering wheel relative to the straight-ahead position of the steering wheel. Conversely, the current controller may limit the operating current of the electric steering wheel heater to a lesser extent as the position of the steering wheel approaches the straight-ahead position of the steering wheel relative to either one of the maximum deflected positions.

The steering wheel is rotatable between a clockwise maximum deflected position and a counterclockwise maximum deflected position. The current controller may limit the operating current of the electric steering wheel heater to a low value when the position of the steering wheel is either the clockwise maximum deflected position or the counterclockwise maximum deflected position. The current controller may limit the operating current of the electric steering wheel heater to values greater than the low value when the position of the steering wheel is a position other than either the clockwise maximum deflected position or the counterclockwise maximum deflected position. The current controller may limit the operating current of the electric steering wheel heater to a high value when the position of the steering wheel is at a position equally between the clockwise maximum deflected position and the counterclockwise maximum deflected position. The current controller may limit the operating current of the electric steering wheel heater to values greater than the low value and lessor than the high value when the position of the steering wheel is a position other than the clockwise maximum deflected position, the counterclockwise maximum deflected position, or the position equally between the clockwise maximum deflected position and the counterclockwise maximum deflected position.

The current controller may limit the operating current of the electric steering wheel heater to a first value at a first position of the steering wheel and limits the operating current of the electric steering wheel heater to a second value at a second position of the steering wheel.

The ribbon cable may be wound most loose inside the coil spring cartridge in the first position of the steering wheel and may be wound most tightly inside the coil spring cartridge in the second position of the steering wheel. In this case, the first value is greater than the second value.

The current controller may limit the operating current of the electric steering wheel heater to a third value at a third position of the steering wheel. The ribbon cable may be wound tighter than most loose and looser than most tightly inside the coil spring cartridge in the third position of the steering wheel. In this case, the third value is lesser than the second value and is greater than the first value.

The current controller may limit the operating current of the electric steering wheel heater as a continuous function of the position of the steering wheel.

The current controller may limit the operating current of the electric steering wheel heater as a discrete function of the position of the steering wheel.

Further, in carrying out the above and/or other objects, a method for use with the steering wheel arrangement may be provided. The method includes detecting, by the steering angle measuring system, a position of the steering wheel. The method further includes limiting, by the current controller, the operating current of the electric steering wheel heater as a function of the position of the steering wheel.

### DETAILED DESCRIPTION

Detailed embodiments of the present invention are disclosed herein; however, it is to be understood that the disclosed embodiments are merely exemplary of the present invention that may be embodied in various and alternative forms.

According to the present invention, a steering wheel heating current control dependent on the steering angle is thus provided. Based on the steering angle information from the steering angle measuring system, an electronics system for the electric steering wheel heater specifies a maximum possible operating current for each steering wheel position.

These maximum current intensities to be adhered to for the various steering angular positions can be empirically determined in advance. For example, these maximum current intensities can be determined under the condition that a predefined limit temperature inside the coil spring cartridge, and particularly at the ribbon cable conducting the operating current to the steering wheel heater, is not exceeded.

It is particularly advantageous for a ribbon cable which conducts the operating current for the steering wheel heater to be situated in the coil spring cartridge in such a way that in the middle position (i.e., the straight-ahead position) of the steering wheel the ribbon cable is wound least tightly inside the coil spring cartridge and in the maximum deflected steering wheel positions is wound most tightly inside the coil spring cartridge. In this case, the limitation of the operating current to the electric steering wheel heater is at a minimum in the straight-ahead position of the steering wheel (i.e., minimum limitation means the operating current can be relatively large) and is at a maximum in the maximum deflected steering wheel positions (i.e., maximum limitation means the operating current can only be relatively small).

In normal driving operation, the steering wheel is usually close to the middle position of the steering wheel. In these steering wheel positions, the ribbon cable is wound least tightly. As such, here the electric steering wheel heater may be operated at maximum current intensity. In contrast, extreme steering wheel angles, at which the transferred electric current intensity must be greatly limited, are relatively uncommon. For the steering wheel positions in between the straight-ahead steering wheel position and the maximum deflected steering wheel positions, the transferred electric current intensity may be appropriately controlled to a middle value(s).

The current intensity may be a function of the rotational angle of the steering wheel, either in stages (i.e., discretely) or continuously. An electronics system is employed which uses either the output signals of the steering angle sensors, or signals or data correspondingly processed from same, to control the operating current to the electric steering wheel heater. This control electronics system (i.e., controller) may be designed either as an analog or a digital circuit.

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. A steering wheel arrangement for a motor vehicle, comprising
a steering wheel;
a steering angle measuring system for detecting a position of the steering wheel;
an electric steering wheel heater;
a coil spring cartridge containing a ribbon cable through which an operating current of the electric steering wheel heater flows; and
a current controller which limits the operating current of the electric steering wheel heater as a function of the position of the steering wheel.

2. The steering wheel arrangement of claim 1 wherein:
the ribbon cable in a straight-ahead position of the steering wheel is wound least tightly inside the coil spring cartridge and in maximum deflected positions of the steering wheel is wound most tightly inside the coil spring cartridge;
the current controller minimally limits the operating current of the electric steering wheel heater in the straight-ahead position of the steering wheel; and
the current controller maximally limits the operating current of the electric steering wheel heater in the maximum deflected positions of the steering wheel.

3. The steering wheel arrangement of claim 2 wherein:
the current controller limits the operating current of the electric steering wheel heater to a greater extent as the position of the steering wheel approaches one of the maximum deflected positions of the steering wheel relative to the straight-ahead position of the steering wheel.

4. The steering wheel arrangement of claim 2 wherein:
the current controller limits the operating current of the electric steering wheel heater to a lesser extent as the position of the steering wheel approaches the straight-ahead position of the steering wheel relative to either one of the maximum deflected positions.

5. The steering wheel arrangement of claim 1 wherein:
the steering wheel is rotatable between a clockwise maximum deflected position and a counterclockwise maximum deflected position;
the current controller limits the operating current of the electric steering wheel heater to a low value when the position of the steering wheel is either the clockwise maximum deflected position or the counterclockwise maximum deflected position; and
the current controller limits the operating current of the electric steering wheel heater to values greater than the low value when the position of the steering wheel is a position other than either the clockwise maximum deflected position or the counterclockwise maximum deflected position.

6. The steering wheel arrangement of claim 5 wherein:
the current controller limits the operating current of the electric steering wheel heater to a high value when the position of the steering wheel is at a position equally between the clockwise maximum deflected position and the counterclockwise maximum deflected position.

7. The steering wheel arrangement of claim 6 wherein:
the current controller limits the operating current of the electric steering wheel heater to values greater than the low value and lessor than the high value when the position of the steering wheel is a position other than the clockwise maximum deflected position, the counterclockwise maximum deflected position, or the position equally between the clockwise maximum deflected position and the counterclockwise maximum deflected position.

8. The steering wheel arrangement of claim 1 wherein:
the current controller limits the operating current of the electric steering wheel heater to a first value at a first position of the steering wheel and limits the operating current of the electric steering wheel heater to a second value at a second position of the steering wheel.

9. The steering wheel arrangement of claim 8 wherein:
the ribbon cable is wound most loose inside the coil spring cartridge in the first position of the steering wheel and the ribbon cable is wound most tightly inside the coil spring cartridge in the second position of the steering wheel; and
the first value is greater than the second value.

10. The steering wheel arrangement of claim 8 wherein:
the current controller limits the operating current of the electric steering wheel heater to a third value at a third position of the steering wheel.

11. The steering wheel arrangement of claim 10 wherein:
the ribbon cable is wound most loose inside the coil spring cartridge in the first position of the steering wheel, the ribbon cable is wound most tightly inside the coil spring cartridge in the second position of the steering wheel, and the ribbon cable is wound tighter than most loose and looser than most tightly inside the coil spring cartridge in the third position of the steering wheel; and
the first value is greater than the second value, and the third value is lesser than the second value and is greater than the first value.

12. The steering wheel arrangement of claim 1 wherein:
the current controller limits the operating current of the electric steering wheel heater as a continuous function of the position of the steering wheel.

13. The steering wheel arrangement of claim 1 wherein:
the current controller limits the operating current of the electric steering wheel heater as a discrete function of the position of the steering wheel.

14. A method for use with a steering wheel arrangement of a motor vehicle, wherein the steering wheel arrangement includes a steering wheel, a steering angle measuring system for detecting a position of the steering wheel, an electric steering wheel heater, and a coil spring cartridge containing a ribbon cable through which an operating current of the electric steering wheel heater flows, the method comprising:
detecting, by the steering angle measuring system, a position of the steering wheel; and
limiting, by a current controller, the operating current of the electric steering wheel heater as a function of the position of the steering wheel.

15. The method of claim 14 further comprising:
limiting, by the current controller, the operating current of the electric steering wheel heater to a greater extent as the position of the steering wheel approaches a maximum deflected position of the steering wheel relative to a middle position of the steering wheel.

16. The method of claim 14 further comprising:
limiting, by the current controller, the operating current of the electric steering wheel heater to a lesser extent as the position of the steering wheel approaches a middle position of the steering wheel relative to a maximum deflected position of the steering wheel.

17. The method of claim 14 further comprising:
limiting, by the current controller, the operating current of the electric steering wheel heater to a first value at a first position of the steering wheel; and
limiting, by the current controller, the operating current of the electric steering wheel heater to a second value at a second position of the steering wheel.

18. The method of claim 17 wherein:
the first value is greater than the second value with the ribbon cable being wound most loose inside the coil spring cartridge in the first position of the steering wheel and the ribbon cable being wound most tightly inside the coil spring cartridge in the second position of the steering wheel.

19. The method of claim 17 further comprising:
limiting, by the current controller, the operating current of the electric steering wheel heater to a third value at a third position of the steering wheel.

20. The method of claim 19 wherein:
the first value is greater than the second value, and the third value is lesser than the second value and greater than the first value, with the ribbon cable being wound most loose inside the coil spring cartridge in the first position of the steering wheel, the ribbon cable being wound most tightly inside the coil spring cartridge in the second position of the steering wheel, and the ribbon cable being wound tighter than most loose and looser than most tightly inside the coil spring cartridge in the third position of the steering wheel.
